(19) United States
(12) Patent Application Publication
(10) Pub. No.: US 2012/0099083 A1
(43) Pub. Date: Apr. 26, 2012

(54) COLOR WHEEL UNIT AND PROJECTION SYSTEM USING THE SAME

(75) Inventors: Taebong Park, Seoul (KR); Myongrock Oh, Seoul (KR); Seungman Jeong, Seoul (KR)

(73) Assignee: LG Innotek Co., Ltd., Seoul (KR)

(21) Appl. No.: 13/380,383

(22) PCT Filed: Jun. 10, 2010
(86) PCT No.: PCT/KR2010/003714

§ 371 Date: Dec. 22, 2011

(30) Foreign Application Priority Data
Jun. 22, 2009 (KR) 10-2009-0055683

(51) Int. Cl. G03B 21/14; G02B 5/22

(52) U.S. Cl. 353/84; 359/889

(57) ABSTRACT

A color wheel unit according to the exemplary embodiments of the present invention is characterized by: a motor; a substrate rotated by the motor; and a plurality of light emitting diodes (LEDs) mounted on the substrate, wherein the substrate is divided into a plurality of regions, and at least one of the regions is mounted with the plurality of light emitting diodes, and the region mounted with the plurality of light emitting diodes is mounted with light emitting diodes emitting the same color.

### TECHNICAL FIELD

The present invention relates to a color wheel unit and a projection system using the same.

### BACKGROUND ART

A projection system is a device capable of presenting still and/or motion video signals from a light source of a light emitting device to one or more viewers by projecting the signals on a front or a rear surface of a screen.

The projection system may be categorized into four types based on operation methods, that is, a CRT (cathode ray tube) method, a DMD (digital micro-mirror device: a trademark of Texas Instruments) method, a reflective liquid crystal panel method, and a transmissive liquid crystal panel method.

With recent trends of miniaturized projection system, a light emitting device (LED) or a laser diode (LD) is receiving attention as a light source. Particularly, demand of LED is on the increase as a light source for the projection system because of its small physical size, low power consumption, long lifetime, environmental friendliness, availability of white color diode and three primary color (red, green and blue) diodes.

Representative conventional methods to express various colors using the light emitting diodes includes a method of passing the white color emitted by a white LED through a color wheel light emitting unit and a method of sequentially emitting tricolors from a red, green and blue light emitting diodes.

However, the method of passing the white color emitted by a white LED through a color wheel light emitting unit suffers from a disadvantage of colors and brightness being degraded as light passes the color wheel light emitting unit. The method of sequentially emitting tricolors from red, green and blue light emitting diodes also suffers from a disadvantage of structure of the projection system being complicated. The conventional method of using LED also suffers from a disadvantage of needing a complex radiating design for preventing degradation of performances caused by heat from the LED.

### DISCLOSURE OF INVENTION

### Technical Problem

In some exemplary embodiments of the present invention, a color wheel unit capable of effectively discharging heat and a projection system using the same are provided.

In some exemplary embodiments of the present invention, a color wheel unit capable of expressing a high brightness and a good color sense and a projection system using the same are provided.

In some exemplary embodiments of the present invention, a color wheel unit of simple structure and a projection system using the same are provided.

### Solution to Problem

In some exemplary embodiments of the present invention, a color wheel unit is characterized by: a motor; a substrate rotated by the motor; and a plurality of light emitting diodes (LEDs) mounted on the substrate, wherein the substrate is divided into a plurality of regions, and at least one of the regions is mounted with the plurality of light emitting diodes, and the region mounted with the plurality of LEDs is mounted with LEDs emitting the same color.

In some exemplary embodiments of the present invention, a projection system is characterized by: a motor; a substrate rotated by the motor; a color wheel unit including a plurality of light emitting diodes mounted on the substrate; a light transmitter converging light emitted by the color wheel unit and uniformly applying the light; an image generator generating an image in response to an image signal using the light that has transmitted the light transmitter; and a projection lens system enlarging the image generated by the image generator and projecting the image on a screen.

### ADVANTAGEOUS EFFECTS OF INVENTION

A color wheel unit capable of effectively discharging heat and a projection system using the same can be advantageously provided.

A color wheel unit capable of expressing a high brightness and a good color sense and a projection system using the same can be advantageously provided.

A color wheel unit of simple structure and a projection system using the same can be advantageously provided.

### BRIEF DESCRIPTION OF DRAWINGS

FIG. 1 is a schematic view illustrating a configuration of a projection system according to an exemplary embodiment of the present invention.

FIG. 2 is a schematic view illustrating a lateral surface of a color wheel unit according to an exemplary embodiment of the present invention.

FIG. 3 is a perspective view illustrating a color wheel unit according to the present invention.

FIG. 4 is a bottom view of a color wheel unit according to the present invention.

FIG. 5 is a plan view illustrating a substrate divided into three regions according to the present invention.

FIG. 6 is a plan view illustrating a substrate divided into four regions according to the present invention.

FIG. 7 is a plan view illustrating a substrate divided into five regions according to the present invention.

FIG. 8 is a plan view illustrating a substrate divided into six regions according to the present invention.

FIG. 9 is a plan view illustrating a substrate divided into eight regions according to the present invention.

### MODE FOR THE INVENTION

Exemplary embodiments of the present invention will now be described in detail with reference to the annexed drawings.

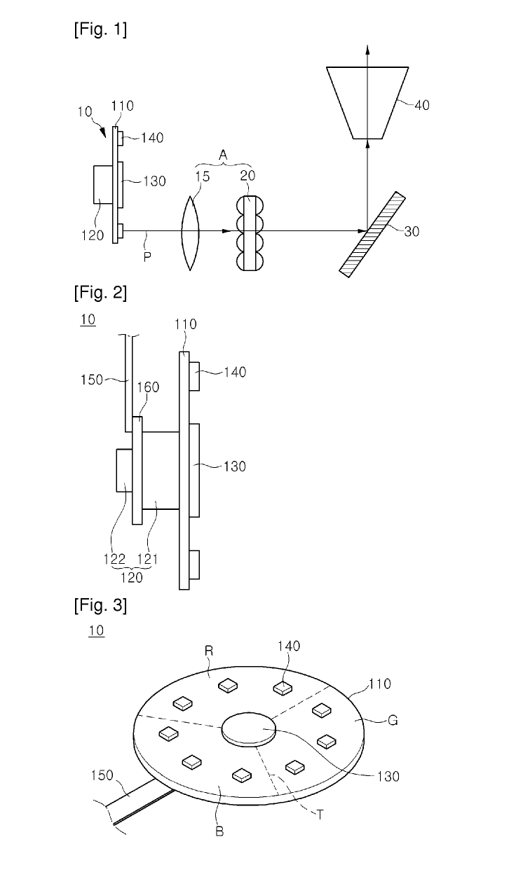

FIG. 1 is a schematic view illustrating a configuration of a projection system using a color wheel unit (10) according to an exemplary embodiment of the present invention.

Referring to FIG. 1, the projection system may include a color wheel unit (10) mounted with a plurality of light emitting diodes emitting light, a light transmitter (A) converging light emitted by the color wheel unit (10) and uniformly applying the light, an image generator (30) generating an image using the light that has transmitted the light transmitter (A); and a projection lens system (40) enlarging the image generated by the image generator (30) and projecting the image on a screen.

The light transmitter (A) may include a condensing lens (15) converging the light emitted from the color wheel unit (10), and a fly eye lens (20) uniformly applying the light that has passed the condensing lens (15).

However, the light transmitter (A) is not limited thereto.

The image generator (30) may include any one of a DMD (Digital Micromirror Device) generating an image by adjusting an reflection angle of microscopic minor responsive to an image signal, and a liquid crystal panel generating an image by selectively reflecting or transmitting light responsive to the image signal. However, there is no limit thereto.

Meanwhile, in a case that the image generator (30) is formed with the liquid crystal panel, a PBS (Polarizing Beam Splitter) may be further interposed between the image generator (30) and the light transmitter (A).

The color wheel unit (10) may include a substrate (110) and a plurality of light emitting diodes (140) mounted on the substrate (110), where the plurality of light emitting diodes (140) provides light to the projection system. The plurality of light emitting diodes (140) may include light emitting diodes having a variety of colors, by which the projection system can be provided with various colors.

The substrate (110) may be divided into several regions, where each region may be mounted with a plurality of light emitting diodes (140). Furthermore, a region mounted with the plurality of light emitting diodes is mounted with LEDs emitting the same color, and the light emitting diodes mounted on the same region may emit light at the same time.

The color wheel unit (10) may include a motor, and may be rotated and driven by the motor. That is, the plurality of light emitting diodes (140) is rotated to provide light to the light transmitter (A) along an optical axle (P).

At this time, in a case a particular region in the multiple regions on the substrate (110) is located on the optical axle (P), the substrate (110) may be so designed as to allow only the plurality of light emitting diodes (140) mounted on the particular region to emit light. Furthermore, the plurality of light emitting diodes (140) may emit light continuously while the color wheel unit (10) is rotated.

The speed of the motor (120) may be synchronized with the image signal inputted to the image generator and the plurality of light emitting diodes (140) to allow the plurality of light emitting diodes emitting light of desired color among the plurality of light emitting diodes (140) to be aligned on the optical axle (P).

As noted above, the projection system using the color wheel unit (10) according to the present exemplary embodiment of the present invention is free from a separate light source that emits light, and receives light from the plurality of light emitting diodes (140) mounted on the color wheel unit (10) to make its configuration simple.

Still furthermore, various color senses have been embodied by allowing the light emitted from a separate light source to pass through the color wheel unit in the conventional method whereby there have occurred changes in color senses and loss of brightness due to the light passing through the color wheel unit. However, the present exemplary embodiment is so configured as to allow the color wheel unit (10) to be mounted with the plurality of light emitting devices (140) emitting various colors to the color wheel unit (10), whereby there is no loss of brightness to enable excellent color senses to be realized.

Hereinafter, the color wheel unit (10) according to the exemplary embodiment of the present invention will be described in detail with reference to FIGS. 2 to 4.

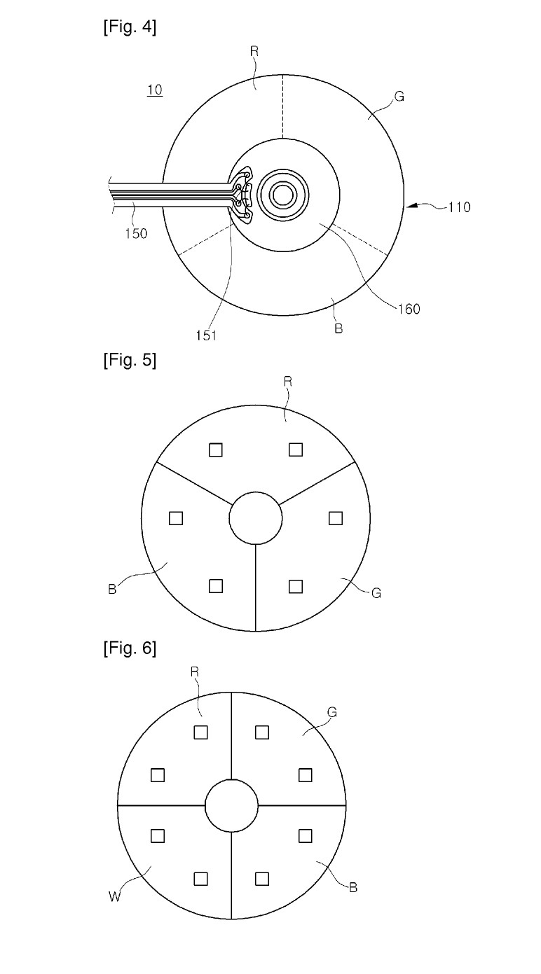

FIG. 2 is a schematic view illustrating a lateral surface of a color wheel unit according to an exemplary embodiment of the present invention, FIG. 3 is a perspective view illustrating a color wheel unit according to the present invention, and FIG. 4 is a bottom view of a color wheel unit according to the present invention.

The color wheel unit (10) may include a plurality of light emitting diodes (140) synchronized with the image generator (30) to emit light, a substrate (110) mounted with the plurality of light emitting diodes (140), a motor (120) for rotating the substrate (110) at a high speed, and a hub (130) for fixing the substrate (110).

The motor (120) rotates the substrate (110) at a high speed and in turn rotates the plurality of light emitting diodes (140) mounted on the substrate (110) to allow emitting the light. That is, the plurality of light emitting diodes (140) is rotated to provide light to the projection system along the optical axle (P).

Meanwhile, because the plurality of light emitting diodes (140) is rotated by the motor (120) to emit light, the color wheel unit (10) and the projection system using the same need no separate radiating device to obtain an effect of radiating heat generated by the plurality of light emitting devices (140) in response to the rotation of the motor (120).

The motor (120) may include a stator (122) supported by a support member (160) and a rotor (121) rotatatively supported by the stator (122). The support member (160) may be supported by a separate support (not shown) formed by being extended from a case of the projection system, and fixedly supports the motor (120), for example.

Referring to FIG. 4, the motor (120) may be electrically connected to a connection line (151) of a cable (150), and receive power by the cable (150). The cable (150) may be a conductor's integration or an FPCB (Flexible Printed Circuit Board).

Meanwhile, the method of the motor (120) receiving the power is not limited to that of using the cable (150), but may be variably changed according to design of the color wheel unit (10).

The substrate (110), which is a PCB (Printed Circuit Board) in which circuits are printed on an insulator, may be a metal core PCB, an FPCB, an aluminum substrate, or a ceramic substrate.

The circuits printed on the substrate (110) are so designed as to allow the plurality of light emitting diodes (140) mounted on the substrate (110), the motor (120) and the image generator (30) to be mutually synchronized and driven together. The substrate (110) is electrically connected to the connection line (151) of the cable (150) to receive the power.

The substrate (110) may take a shape formed with an opening into which a driving axle of the motor (120) is inserted. The substrate (110) may be integrally formed to prevent from being disengaged by the centrifugal force even if the substrate is rotated by the motor (120).

The substrate (110) may be formed with a colored material having a high reflection efficiency, such as white or silver material. The substrate (110) may be coated on surface thereof with silver (Ag) or the like to increase the reflection efficiency.

The plurality of light emitting diodes (140) is mounted on the substrate (110) in an array formation. The substrate (110) may be divided into multiple regions, at least one of the region being mounted with the plurality of light emitting diodes (140), and the same region mounted with the plurality of light emitting diodes is mounted in array with the light emitting diodes emitting the same color. However, the mounting method is not limited thereto. The plurality of light emitting diodes (140) may include light emitting diodes emitting various colors such as red, green, blue, white and yellow.

Referring to FIG. 3, for example, the substrate (110) may be divided into a red region (R), a green region (G) and a blue region (B), where the red region (R) may be mounted in array with a plurality of red light emitting diodes, the green region (G) may be mounted in array with a plurality of green light emitting diodes, and the blue region (B) may be mounted in array with a plurality of blue light emitting diodes. For convenience of description, a region dividing line (T) is illustrated in order to discern each region of the substrate (110).

Meanwhile, the substrate (110) is not limited to the above-mentioned in which each region (R, G, B) has an equal size of area. The dividing method of regions on the substrate (110) may be variably changed according to design unlike what is shown in the figure. Furthermore, although each region of the substrate is arranged with three light emitting diodes in the figure, it is not limited thereto and the number of light emitting diodes and arrangement types may be changed as necessary.

FIGS. 5 to 9 illustrate examples of mounting methods of light emitting diodes (140) by dividing the substrate (110) into various regions. For convenience sake, the figures illustrate only the substrate (110) of color wheel unit (10) and the plurality of light emitting diodes.

FIG. 5 is a plan view illustrating a substrate divided into three regions according to the present invention.

The three regions may include a red region (R), a green region (G) and a blue region (B), where each region may be mounted with a plurality of light emitting diodes (140) that emits a colored light corresponding to each region.

FIG. 6 is a plan view illustrating a substrate divided into four regions according to the present invention. The four regions may include a red region (R), a green region (G), a blue region (B) and a white region (W), where each region may be mounted with a plurality of light emitting diodes (140) that emits a colored light corresponding to each region.

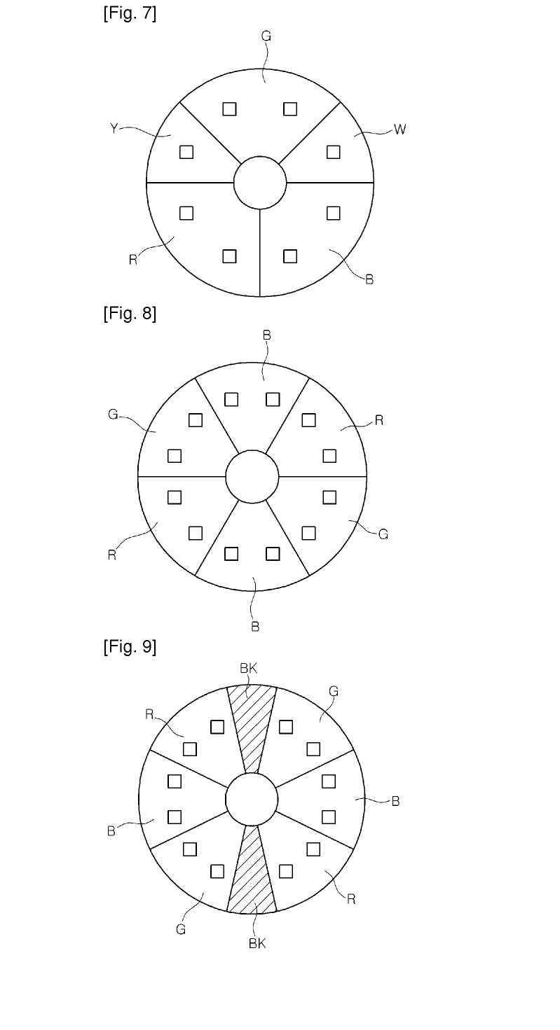

FIG. 7 is a plan view illustrating a substrate divided into five regions according to the present invention. The five regions may include a red region (R), a green region (G), a blue region (B), a white region (W) and a yellow region (Y), where each region may be mounted with a plurality of light emitting diodes (140) that emits a colored light corresponding to each region. At this time, the yellow region (Y) and the white region (W) may have an area smaller than that of other regions.

FIG. 8 is a plan view illustrating a substrate divided into six regions according to the present invention. The six regions may include two red regions (R), two green regions (G) and two blue regions (B), where each of two regions may be mounted with a plurality of light emitting diodes (140) that emits a colored light corresponding to each of two regions. At this time, the two regions of the same color may face each other.

FIG. 9 is a plan view illustrating a substrate divided into eight regions according to the present invention. The eight regions may include two red regions (R), two green regions (G), two blue regions (B) and two black regions (BK), where each of two regions except for the black regions (BK) may be mounted with a plurality of light emitting diodes (140) that emits a colored light corresponding to each of two regions.

The black regions (BK) may be formed with regions where no light is emitted and may not be mounted with a plurality of light emitting diodes (140). At this time, the two regions of the same color may face each other. The black regions may be smaller than the other regions.

The dividing method of the substrate (110) is just illustrative and may be changed. Each region may be properly divided to enhance the color senses of the images and to remove rainbow phenomenon. The plurality of light emitting diodes (140) mounted on each region of the substrate (110) is rotated by the motor (120) to emit light. That is, the plurality of light emitting diodes (140) is rotated along the optical axle (P) to provide light to the projection system.

At this time, in a case a particular region of the substrate (110) is placed on the optical axle (P) while the plurality of light emitting diodes (140) is rotated, only the light emitting diodes mounted on the particular corresponding region is controlled to emit light, or the light emitting diodes may be controlled to continuously emit light regardless of whether the particular region of the substrate (110) is placed on the optical axle (P).

In a case the particular region on the substrate (110) is placed on the optical axle (P) and only the light emitting diodes mounted on the relevant region is controlled to emit light, the time in which the plurality of light emitting diodes is controlled to emit light can be reduced to thereby decrease the power consumption and heat generation.

Furthermore, because the plurality of light emitting diodes (140) emits light while being rotated by the motor (120), the color wheel unit (10) and the projection system using the same can obtain an effect of discharging the heat generated by the plurality of light emitting diodes using the rotation of the motor (120) without recourse to installation of no separate heat radiating device.

The rotating speed of the motor (120) may synchronize with that of the image signal inputted into the image generator (30) to allow the light emitting diodes mounted on a region of desired color out of the plurality of light emitting diodes to be placed on the optical axle (P).

The hub (130) may fix the substrate (110) to prevent the substrate (110) from being disengaged from the motor (120). The hub (130) may be attached to the substrate (110) using adhesive, or may be coupled to the substrate (110) using coupling screws.

While the present disclosure has been particularly shown and described with reference to exemplary embodiments thereof, the general inventive concept is not limited to the above-described embodiments. It will be understood by those of ordinary skill in the art that various changes and variations in form and details may be made therein without departing from the spirit and scope of the present invention as defined by the following claims.

### INDUSTRIAL APPLICABILITY

The present invention provides a color wheel unit and a projection system capable of effectively discharging heat and expressing a high brightness and a good color sense.

1. A color wheel unit, characterized by:
a motor; a substrate rotated by the motor;
and a plurality of light emitting diodes (LEDs) mounted on the substrate, wherein the substrate is divided into a plurality of regions, and at least one of the regions is mounted with the plurality of light emitting diodes, and the region mounted with the plurality of light emitting diodes is mounted with light emitting diodes emitting the same color.

2. The color wheel unit of claim 1, wherein the substrate is one of a printed circuit board, an aluminum substrate and a ceramic substrate.

3. The color wheel unit of claim 1, wherein the substrate is integrally formed and has an opening into which the motor is inserted.

4. The color wheel unit of claim 1, wherein the substrate is coated or made of white or silver material in order to enhance a reflection efficiency.

5. The color wheel unit of claim 1, wherein the plurality of light emitting diodes emits at least one of red, green, blue, white or yellow color.

6. The color wheel unit of claim 1, wherein the light emitting diodes and the motor are synchronized and driven together.

7. The color wheel unit of claim 1, wherein the light emitting diodes mounted on the same region of the substrate emit light at the same time.

8. A projection system, characterized by:
a motor; a substrate rotated by the motor;
a color wheel unit including a plurality of light emitting diodes mounted on the substrate;
a light transmitter converging light emitted by the color wheel unit and uniformly applying the light;
an image generator generating an image in response to an image signal using the light that has transmitted the light transmitter;
and a projection lens system enlarging the image generated by the image generator and projecting the image on a screen.

9. The projection system of claim 8, wherein the light transmitter includes a condensing lens converging the light emitted from the color wheel unit, and a fly eye lens uniformly applying the light that has passed the condensing lens.

10. The projection system of claim 8, wherein the image generator is a DMD (Digital Micromirror Device).

11. The projection system of claim 8, wherein a PBS (Polarizing Beam Splitter) is interposed between the image generator and the light transmitter, and the image generator is a liquid crystal panel.

12. The projection system of claim 8, wherein the substrate is divided into multiple regions, and at least one of the regions is mounted with the plurality of light emitting diodes, and the region mounted with the plurality of light emitting diodes is mounted with light emitting diodes emitting the same color.

13. The projection system of claim 8, wherein the plurality of light emitting diodes are rotated by the motor to provide light to the light transmitter along an optical axle.

14. The projection system of claim 13, wherein only the light emitting diodes mounted on a particular region emit light in a case the particular region on the substrate is placed on the optical axle.

15. The projection system of claim 13, wherein the plurality of light emitting diodes keeps emitting light while being rotated.

16. The projection system of claim 8, wherein the rotating speed of the motor is synchronized with the image signal inputted into the image generator.

17. The color wheel unit of claim 2, wherein the substrate is coated or made of white or silver material in order to enhance a reflection efficiency.

18. The color wheel unit of claim 6, wherein the light emitting diodes mounted on the same region of the substrate emit light at the same time.

19. The projection system of claim 12, wherein the plurality of light emitting diodes are rotated by the motor to provide light to the light transmitter along an optical axle.
